(19) United States
(12) Patent Application Publication
(10) Pub. No.: US 2025/0192410 A1
(43) Pub. Date: Jun. 12, 2025

(54) FILTER FOR COMMUNICATION DEVICE

(71) Applicant: KMW INC., Hwaseong-si (KR)

(72) Inventors: Nam Shin PARK, Hwaseong-si (KR); Sung Ho JANG, Yongin-si (KR); Jae Hong KIM, Yongin-si (KR); Yeon Ho SHIN, Yongin-si (KR); Jeong Moon OH, Hwaseong-si (KR)

(73) Assignee: KMW INC., Hwaseong-si (KR)

(21) Appl. No.: 19/060,604

(22) Filed: Feb. 21, 2025

Related U.S. Application Data
(63) Continuation of application No. PCT/KR2023/012576, filed on Aug. 24, 2023.

(30) Foreign Application Priority Data
Aug. 26, 2022 (KR) 10-2022-0107871
Aug. 23, 2023 (KR) 10-2023-0110839

(51) Int. Cl. H01P 1/207

(52) U.S. Cl. CPC H01P 1/207

(57) ABSTRACT

Disclosed herein may be a filter for communication devices. The filter may include a base plate that is made of a conductive material, manufactured in an unfolded state and configured to be foldable such that, upon folding, a cavity is formed inside while simultaneously positioning a plurality of resonators to protrude by a set length in a thickness direction or a width direction in the cavity. The plurality of resonators may each include, at a distal end portion thereof, a resonance characteristic end that is flat to form a layer identical to a remaining portion in the cavity and has a greater width than the remaining portion. The aforementioned configuration provides advantages of facilitating a slim product design, reducing insertion loss, and enhancing resonance characteristics.

### TECHNICAL FIELD

The present disclosure relates to a filter for communication devices and, more particularly, to a filter for communication devices that is easy to manufacture, facilitates securing of a usable area of a main board (or power amplifier (PA) board), and prevents an increase in the size of an entire antenna device in a thickness direction.

### BACKGROUND ART

Radio frequency devices (including all “communication devices”), such as radio frequency filters, are typically configured with a connected structure of a plurality of resonators. Such resonators are circuit elements that resonate at specific frequencies through a combination of an inductor (L) and a capacitor (C) in terms of equivalent electronic circuits. Each resonator has a structure in which a dielectric resonance element (DR) or a metallic resonance element is installed in a cavity, such as a metallic cylindrical or rectangular parallelopiped cavity enclosed by conductors. Accordingly, each resonator allows only an electromagnetic field of a unique frequency corresponding to a processing frequency band to exist within the associated cavity, thereby enabling high-frequency resonance. Typically, the resonator has a multi-stage structure in which a plurality of cavities are used to form a plurality of resonant stages, and the plurality of resonant stages are sequentially connected.

An example of a radio frequency filter having a multi-cavity structure may include the invention disclosed in Korean Patent Application Laid-Open No. 10-2004-0100084 (Title: “Radio frequency filter,” Publication Date: Dec. 2, 2004), which was previously filed by the present applicant.

However, conventional radio frequency filters are configured such that each resonator extends in a thickness direction within a cavity, and a portion of a filter tuning cover, which covers the cavity to achieve desired band-pass characteristics, is deformed through a punching process to tune the distance to the resonator, resulting in a significant limitation in reducing the size of the completed filter in the thickness direction.

Furthermore, conventional radio frequency filters require installation of additional conductive components to implement inductive coupling or capacitive coupling as part of enhancing skirt characteristics between adjacent resonators or spaced-apart resonators within a plurality of cavities, resulting in a significant increase in the weight of the completed filter. Recently, in antenna devices utilizing massive multiple input multiple output (MMO) technology, research has been conducted to minimize the thickness of internal components, such as filters, to achieve a slimmer overall product design. Among the most commonly used filter types for the foregoing purpose, a dielectric ceramic filter is a representative example.

However, dielectric ceramic filters, due to the characteristics of the material thereof, are configured to be directly coupled in close contact with one surface of a main board (or PA board) stacked inside an antenna housing, thereby inherently limiting the double-sided use of a printed circuit board (PCB).

### DISCLOSURE

### Technical Problem

The present disclosure has been made to solve the technical problem, and an object of the present disclosure is to provide a filter for communication devices that can eliminate conventional joining processes for forming a cavity and providing structures such as resonators within the cavity, thereby reducing insertion loss caused by coupling of two physical structures.

Furthermore, another object of the present invention is to provide a filter for communication devices, in which resonance characteristic ends of a plurality of resonators provided in a cavity can be easily manufactured using a folding method.

The technical objects of the present disclosure are not limited to the above-stated objects, and those skilled in the art will clearly understand other not mentioned objects from the following description.

### Technical Solution

A filter for communication devices according to an embodiment of the present disclosure may include a base plate made of a conductive material, and manufactured in an unfolded state, the base plate being configured foldable such that, upon folding, a cavity is formed inside while simultaneously positioning a plurality resonators to protrude by a set length in a thickness direction or a width direction in the cavity. The plurality of resonators may each include, at a distal end portion thereof, a resonance characteristic end that is flat to form a layer identical to a remaining portion in the cavity and has a greater width than the remaining portion.

Here, at least one of the plurality of resonators may be integrally formed with an input terminal pin connected to an input port so that a signal transmitted from the input port is received. At least one other of the plurality of resonators may be integrally formed with an output terminal pin connected to an output port so that a signal is transmitted to and output from the output port.

Furthermore, the resonance characteristic end of each of the plurality of resonators may integrally extend to be angled from a leading end of the remaining portion.

Furthermore, the resonance characteristic end of each of the plurality of resonators may be integrally formed to extend to be rounded from a leading end of the remaining portion.

In addition, the resonance characteristic end of each of the plurality of resonators may integrally extend in a “U” shape that surrounds a leading end of the remaining portion.

Additionally, the base plate may be made of either a conductive material or a non-conductive material. In case that the base plate is made of the non-conductive material, a conductive material may be formed as a coating layer by plating at least on an interior corresponding to the cavity.

Furthermore, the cavity may be filled with air having a dielectric constant of 1.

Furthermore, the base plate, after folding, may include a body bottom forming panel that forms a bottom surface of the cavity, a first-side thickness forming panel and a second-side thickness forming panel that increase a size of the cavity C in a thickness direction, a resonator panel provided with a plurality of resonators that protrude into the cavity at a position corresponding to space above the body bottom forming panel, and a body top forming panel provided in a shape covering a top of the cavity.

In addition, the base plate, after folding, may further include a first-side shielding panel and a second-side shielding panel that shield a first longitudinal end and a second longitudinal end of the cavity.

Furthermore, the base plate, after folding, may further include a notch forming panel provided between the body top forming panel and the plurality of resonators of the resonator panel.

Furthermore, the plurality of resonators is integrally formed with an input terminal pin connected to an input port so that a signal transmitted from the input port is received. At least one other of the plurality of resonators may be integrally formed with an output terminal pin connected to an output port so that a signal is transmitted to and output from the output port. An input port installation portion and an output port installation portion, through which the input terminal pin or the output terminal pin are installed may be formed in a boss shape to vertically penetrate through the body bottom forming panel. A fixing protrusion portion for securing installation of a Teflon component may be formed, to have a stud or serration-like projection shape, on an inner circumferential surface of a hole defined in each of the input port installation portion and the output port installation portion.

### Advantageous Effects

According to a filter for communication devices of the present disclosure, since the filter is configured to allow the construction of structures in a cavity through a simple folding process without using a conventional joining method (welding or brazing), it is possible to reduce insertion loss caused by the application of the joining method, thereby improving communication reliability.

Furthermore, the present disclosure allows the formation of the cavity using a thin base plate of 3t or less, thereby reducing a thickness direction size of an entire product of an antenna device and enhancing the effects of weight reduction and slimming of the product.

### DESCRIPTION OF DRAWINGS

FIG. 1 is a perspective view illustrating a filter for communication devices according to a first embodiment of the present disclosure,

FIG. 2 is an internal perspective view of FIG. 1,

FIG. 3 is a perspective view illustrating an unfolded state of a base plate among components of FIG. 1,

FIG. 4 is a plan view of FIG. 3,

FIG. 5 is an exploded perspective view illustrating an embodiment in which an input terminal pin and an output terminal pin among the components of FIG. 1 are provided as separate elements,

FIG. 6 shows cutaway perspective views (a and b) taken along line A-A,

FIG. 7 is a cross-sectional view and a partially enlarged plan view illustrating a structure for fixing the input terminal pin and the output terminal pin among the components of FIG. 1,

FIG. 8 is a perspective view illustrating a first implementation of a plurality of resonators among the components of FIG. 1,

FIG. 9 is a perspective view illustrating a filter for communication devices according to a second embodiment of the present disclosure,

FIG. 10 is an internal perspective view of FIG. 9,

FIG. 11 is a plan view of a base plate among components of FIG. 9,

FIG. 12 is an exploded perspective view illustrating an embodiment in which an input terminal pin and an output terminal pin among the components of FIG. 9 are provided as separate elements,

FIGS. 13 and 14 are cutaway perspective views illustrating a state in which a portion of an upper plate forming part among the components of FIG. 9 is removed along lines B-B and C-C, respectively,

FIG. 15 is a perspective view and a partially enlarged view of FIG. 9,

FIG. 16 is a perspective view illustrating a second implementation of a plurality of resonators among the components of FIG. 9,

FIG. 17 is a perspective view illustrating a filter for communication devices according to a third embodiment of the present disclosure,

FIG. 18 is an internal perspective view of FIG. 17,

FIG. 19 is a plan view of a base plate among components of FIG. 17,

FIG. 20 is an exploded perspective view illustrating an embodiment in which an input terminal pin and an output terminal pin among the components of FIG. 17 are provided as separate elements,

FIG. 21 shows cutaway perspective views (a and b) taken along line D-D,

FIG. 22 is a perspective view illustrating a filter for communication devices according to a fourth embodiment of the present disclosure,

FIG. 23 is an internal perspective view of FIG. 22,

FIG. 24 is a plan view of a base plate among components of FIG. 22,

FIG. 25 is an exploded perspective view illustrating an embodiment in which an input terminal pin and an output terminal pin among the components of FIG. 22 are provided as separate elements,

FIG. 26 is a cutaway perspective view taken along line E-E,

FIG. 27 is a perspective view illustrating an unfolded state of a form closest to an actual product according to embodiments of the present disclosure, and

FIG. 28 is a perspective view illustrating a state in which a portion of the base plate of FIG. 27 is folded.

### DESCRIPTION OF THE REFERENCE NUMERALS

100: First embodiment 105: Base plate
110: Body bottom forming panel 120: First-side thickness forming panel
130: Second-side thickness forming panel 140: Notch forming panel
150: Body top forming panel 160: Resonator panel
170: Resonators 200: Second embodiment
300: Third embodiment 400: Fourth embodiment

### BEST MODE

Hereinafter, a filter for communication devices according to embodiments of the present disclosure will be described in detail with reference to the attached drawings.

In adding reference numerals to elements in each drawing, the same elements will be designated by the same reference numerals, if possible, although they are shown in different drawings. Furthermore, in the following description of the disclosure, a detailed description of known functions and configurations incorporated herein will be omitted when it is determined that the description may make the subject matter of the disclosure rather unclear.

The terms “first”, “second”, “A”, “B”, “(a)”, “(b)”, etc. may be used herein to describe various elements of the embodiments of the present disclosure. These terms are only used to distinguish each element from another element, and do not limit the characteristics, turns, or sequences of the corresponding elements. Unless otherwise defined, all terms including technical and scientific terms used herein have the same meaning as commonly understood by one of ordinary skill in the art to which the present disclosure belongs. It will be further understood that terms commonly used and defined in standard dictionaries should be interpreted as having a meaning that is consistent with their meaning in the context of this specification and the relevant art and will not be interpreted in an idealized or overly formal sense unless expressly so defined herein.

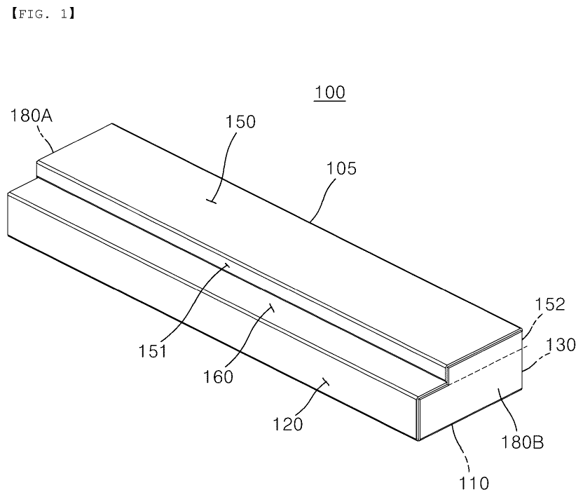

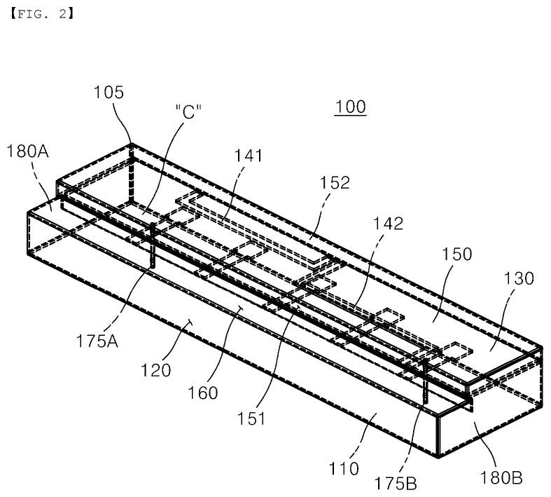

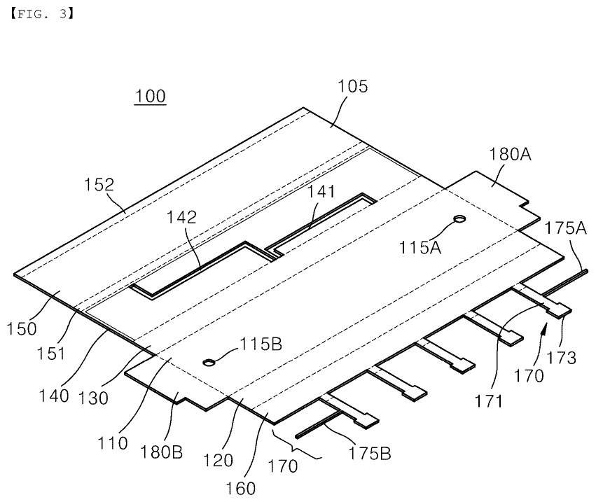

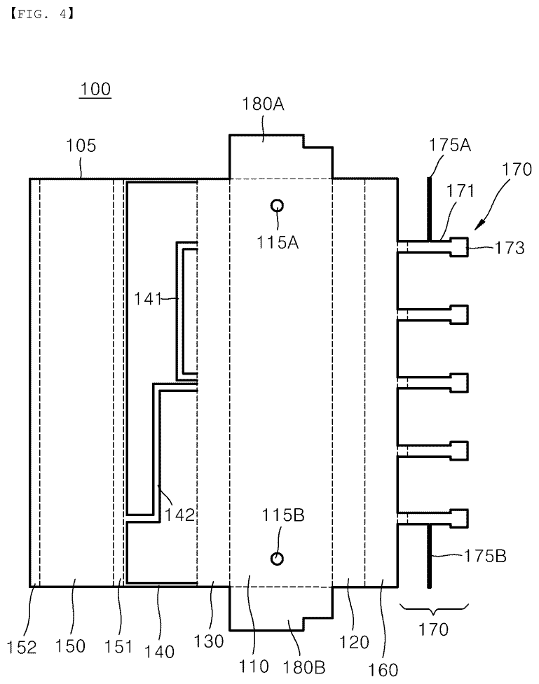

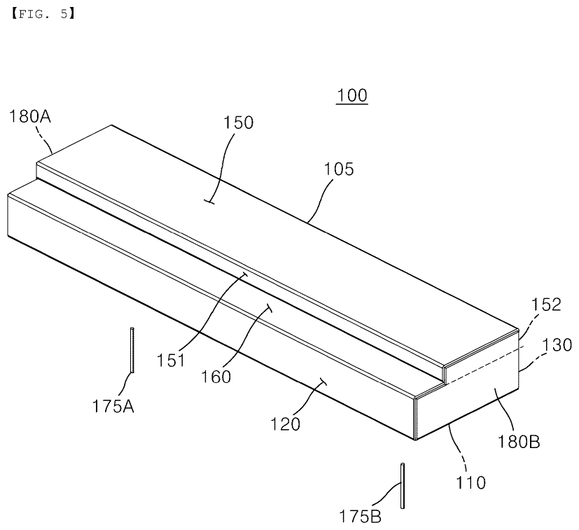

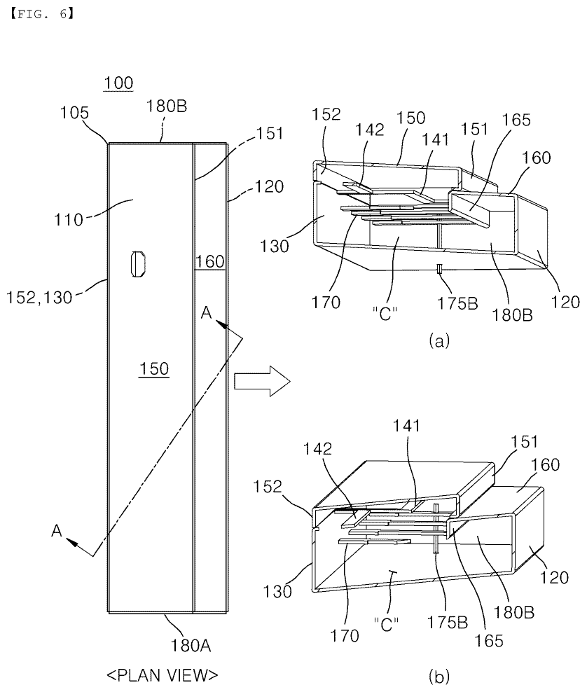

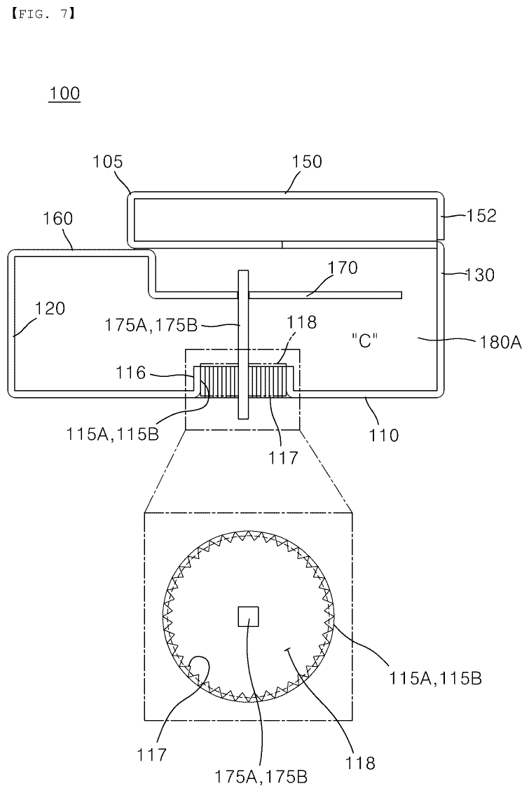

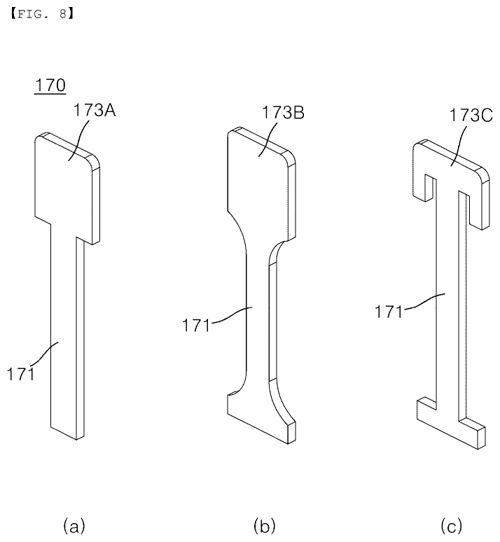

FIG. 1 is a perspective view illustrating a filter for communication devices according to a first embodiment of the present disclosure. FIG. 2 is an internal perspective view of FIG. 1. FIG. 3 is a perspective view illustrating an unfolded state of a base plate among components of FIG. 1. FIG. 4 is a plan view of FIG. 3. FIG. 5 is an exploded perspective view illustrating an embodiment in which an input terminal pin and an output terminal pin among the components of FIG. 1 are provided as separate elements. FIG. 6 shows cutaway perspective views (a and b) taken along line A-A. FIG. 7 is a cross-sectional view and a partially enlarged plan view illustrating a structure for fixing the input terminal pin and the output terminal pin among the components of FIG. 1. FIG. 8 is a perspective view illustrating a first implementation of a plurality of resonators among the components of FIG. 1.

Generally, filters in the field of antenna technology perform a role of filtering signals that need to be input or output to allow only signals within a specific frequency band to pass during signal transmission and reception processes, thereby ensuring that only the signals desired by a consumer (user) are obtained as a final result.

For such signal filtering, a cavity filter, as indicated by the name thereof, forms a cavity as a predetermined signal filtering section between an input port, where signals are input, and an output port, where signals are output, thereby enabling acquisition of specific frequency band signal values within a range desired by the consumer through a frequency tuning process using the cavity.

However, to date, in the industry manufacturing antenna devices, the only disclosed method for manufacturing a cavity filter is a method that includes forming the aforementioned cavity by processing an interior of a filter body made of a ceramic material or a material with higher rigidity, and then separately manufacturing essential components for frequency filtering, such as a plurality of resonators, and fixing the components inside the cavity.

However, the filter for communication devices according to embodiments of the present disclosure departs from the aforementioned manufacturing method and discloses a groundbreaking technical feature that enables the construction of a structure within the cavity without using a separate bonding process by processing a single and flat base plate in the form of sheet metal to a thickness not exceeding a predetermined value, and performing a folding process. Hereinafter, specific technical features will be described sequentially in the order of the embodiments.

A filter 100 for communication devices according to the first embodiment of the present disclosure is manufactured in an unfolded state and includes a conductive base plate 105 configured to be foldable so that when folded, the base plate 105 forms a cavity C therein and allows a plurality of resonators 170, which protrude a predetermined length in the thickness direction or width direction, to be positioned inside the cavity C.

The base plate 105 is preferably made of a conductive material; however, it should be noted in advance that the base plate 105 may also be made of a non-conductive material for ease of manufacturing, and to enable the cavity C to perform the function thereof, a conductive material may subsequently form a coating layer by plating on both the interior and exterior, including the cavity C, or at least on the interior corresponding to the cavity C.

However, the base plate 105 is preferably made of a deformable material that can be suitably processed, as the base plate 105 is required to continuously maintain the shape thereof after being deformed through the folding process, as described below, unless subjected to an external force.

Here, the cavity C is a dielectric-filled space in which a dielectric material having a predetermined dielectric constant is filled, referring to a space that remains empty to allow the dielectric material to be charged. Since air is also a type of dielectric with a dielectric constant of 1, it should be noted in advance that when atmospheric-pressure air is adopted as the dielectric material, a separate dielectric filling process is not required.

In the filter 100 for communication devices according to the first embodiment of the present disclosure, the base plate 105 serves to form the cavity C, which functions as a dielectric-filled space.

Here, as referenced in FIGS. 3 and 4, the base plate 105 may include: a body bottom forming panel 110, which forms a bottom surface of the cavity C after folding; a first-side thickness forming panel 120 and a second-side thickness forming panel 130, which extend in a plane from a first widthwise end and a second widthwise end of the body bottom forming panel 110 such that the width of the body bottom forming panel 110 increases, thereby increasing the size of the cavity C in the thickness direction; a resonator panel 160, which extends from a distal end of either the first-side thickness forming panel 120 or the second-side thickness forming panel 130 and is provided with a plurality of resonators 170 that protrude into the cavity C at a position corresponding to space above the body bottom forming panel 110; and a body top forming panel 150, which extends from a distal end of a remaining one of the first-side thickness forming panel 120 and the second-side thickness forming panel 130 and is provided in a shape covering the top of the cavity C to face the body bottom forming panel 110.

Furthermore, a first-side shielding panel 180A and a second-side shielding panel 180B, which shield an open first longitudinal end and an open second longitudinal end of the cavity C, may integrally extend from the first longitudinal end and the second longitudinal end of the body bottom forming panel 110.

Here, the first-side shielding panel 180A and the second-side shielding panel 180B are described as being integrally formed with the body bottom forming panel 110, but it is apparent that, depending on the embodiment, the first-side shielding panel 180A and the second-side shielding panel 180B may also be symmetrically and integrally provided on an adjacent panel, such as the body top forming panel 150. Furthermore, the first-side shielding panel 180A and the second-side shielding panel 180B may be integrally formed with adjacent panels to be separately provided in two components, respectively, and may be configured to completely shield the open portions of the cavity C through the folding operation.

The body bottom forming panel 110 may be provided with an input port installation portion 115A and an output port installation portion 115B, which are respectively formed to vertically penetrate the first longitudinal end and the second longitudinal end. An input terminal pin 175A, which will be described later, may be installed through the input port installation portion 115A, and an output terminal pin 175B, which will be described later, may be installed through the output port installation portion 115B.

Particularly, as referenced in FIG. 7, the input port installation portion 115A and the output port installation portion 115B are formed as circular holes larger than the horizontal cross-sectional area of the input terminal pin 175A or the output terminal pin 175B. A portion of an edge of each of the holes may protrude a predetermined length inward into the cavity C to form a boss portion 116.

Here, a Teflon component 118 is provided on an outer surface of the input terminal pin 175A or the output terminal pin 175B for impedance matching. A fixing protrusion portion 117 having a stud or serration-like projection shape is integrally formed, to ensure stable installation of the Teflon component 118, on an inner circumferential surface of the hole in each of the input port installation portion 115A and the output port installation portion 115B, where the boss portion 116 is provided. The Teflon component 118 is press-fitted into and securely fixed to the hole, thereby minimizing insertion loss.

In addition, as referenced in FIGS. 3 and 4, the base plate 105 may further include a notch forming panel 140, which is provided between the body top forming panel 150, which connects the first-side thickness forming panel 120 and the second-side thickness forming panel 130, and the resonators 170 of the resonator panel 160. The notch forming panel 140 is arranged to extend in a horizontal direction (or thickness direction) in the cavity C.

The notch forming panel 140 is provided in the form of a frame that is penetrated in the vertical direction, having a shape corresponding to a peripheral shape of the cavity C, and may be formed with an L-notch portion 141 and a C-notch portion 142, each having a specific shape, at a first inner end and a second inner end in the width direction.

The L-notch portion 141 and the C-notch portion 142 are not necessarily required to be provided on the notch forming panel 140, and it is apparent that the L-notch portion 141 and the C-notch portion 142 may be integrally formed on the body top forming panel 150, as long as they can be subsequently modified within a permissible range inside the cavity C by an operator who performs frequency tuning later.

As referenced in FIGS. 3 and 4, in the case where the notch forming panel 140 is provided together with the body top forming panel 150, a first-side spacing panel 151 and a second-side spacing panel 152, which space the notch forming panel 140 and the body top forming panel 150 apart from each other in the thickness direction within the cavity C, may be further integrally provided on the base plate 105.

Here, a lower end of the second-side spacing panel 152 may be welded to an upper end of the second-side thickness forming panel 130, which is a starting portion (first end) where the notch forming panel 140 is formed, after the folding of the body top forming panel 150 is completed.

Furthermore, an ending portion (second end) of the notch forming panel 140, which corresponds to a lower end of the first-side spacing panel 151, may be welded to an upper surface of a portion of the resonator panel 160 that overlaps the ending portion in the thickness direction, after the folding of the resonator panel 160 is completed.

The body top forming panel 150 may be integrally formed, by cutting, with frequency tuning bars (not shown), which perform fine frequency tuning by adjusting a separation distance from the plurality of resonators 170 that are arranged to form a single layer in the thickness direction inside the cavity C, and a plurality of coupling adjustment bars (not shown), which are each deformed directly downward between the plurality of resonators 170.

It is apparent that the body top forming panel 150 may be formed with a tool insertion hole (not shown) penetrating vertically to allow the aforementioned L-notch portion 141 and C-notch portion 142 to be deformed using a predetermined tool.

As referenced in FIGS. 2 to 7, for example, on the assumption that the cavity C, generated by folding each portion of the base plate 105, is formed as a slim rectangular parallelepiped that is relatively long in a longitudinal direction and has a markedly small vertical thickness compared to front-rear and width directions, the plurality of resonators 170 may be provided to form a single uniform layer in the thickness direction of the cavity C.

The L-notch portion 141 and the C-notch portion 142 provided on the notch forming panel 140 may also form a single uniform layer in the thickness direction of the cavity C but may be provided to form a distinct single layer separate from the aforementioned plurality of resonators 170.

Since the thickness of each of the single layer formed by the plurality of resonators 170 and the single layer formed by the L-notch portion 141 and the C-notch portion 142 corresponds to none other than the thickness of the base plate 105 and the single layer is provided with a markedly slim thickness, it provides the advantage of enabling a slim design as desired by the designer without increasing the overall size, including the thickness of the entire product.

As referenced in FIG. 8, the plurality of resonators 170 may each include, at a distal end portion thereof, a resonance characteristic end 173 that is flat to form the same layer as a remaining portion within the cavity C and has a greater width than the remaining portion. Hereinafter, for convenience of explanation, among the structural portions of each of the plurality of resonators 170, a body portion that integrally extends from the base plate 105 and is connected at the distal end portion thereof to the resonance characteristic end 173 is referred to as a resonance bar 171.

At least one of the plurality of resonators 170 may be integrally formed with the input terminal pin 175A that is connected to an input port (not shown) so that a signal transmitted from the input port is input to the at least one resonator 170. At least one other of the plurality of resonators 170 may be integrally formed with an output terminal pin 175B that is connected to an output port (not shown) so that a signal is transmitted to the output port and then output.

As referenced in FIG. 8a, the resonance characteristic end 173 of each of the plurality of resonators 170 may integrally extend to be angled from the leading end of the remaining portion (resonance bar 171).

Alternatively, as referenced in FIG. 8b, the resonance characteristic end 173 of each of the plurality of resonators 170 may integrally extend to be rounded from the leading end of the remaining portion (resonance bar 171).

As a final example, as referenced in FIG. 8c, the resonance characteristic end 173 of each of the plurality of resonators 170 may integrally extend in a ‘U’ shape that surrounds the leading end of the remaining portion (resonance bar 171).

A brief explanation of a method for manufacturing the filter for communication devices according to the first embodiment of the present invention, which is configured as described above, is as follows.

First, after preparing the base plate 105 made of a conductive or non-conductive material (a base plate preparation process), the base plate 105 may be transferred to a press mold and subjected to press sheet metal processing in a pre-designed shape (a press sheet metal processing process).

In this case, as described above, the base plate 105 is preferably designed as a sheet metal structure to form the cavity C, which is shielded from the outside by the body bottom forming panel 110, the first-side thickness forming panel 120, the second-side thickness forming panel 130, the first-side shielding panel 180A, the second-side shielding panel 180B, the body top forming panel 150, and other panels directly connected thereto (e.g., the first-side spacing panel 151 and the second-side spacing panel 152), through a folding process described later.

After performing press sheet metal processing on the base plate 105 through the press sheet metal processing process, in the case where the base plate 105 is made of a non-conductive material, a separate conductive coating process may be additionally performed so that a conductive material forms a coating layer on the entire interior of at least the cavity C, and subsequently, a folding process may be sequentially performed to form the cavity C.

Here, the folding process includes sequentially folding the panels associated with forming the cavity C from the bottom to the top, with reference to the body bottom forming panel 110. During the folding process, the panels are folded so that the plurality of resonators 170 formed on the resonator panel 160 form the same layer (or a single layer) within the cavity C, while the L-notch portion 141 and the C-notch portion 142 formed on the notch forming panel 140 form a distinct single layer separate from the plurality of resonators 170 within the cavity C.

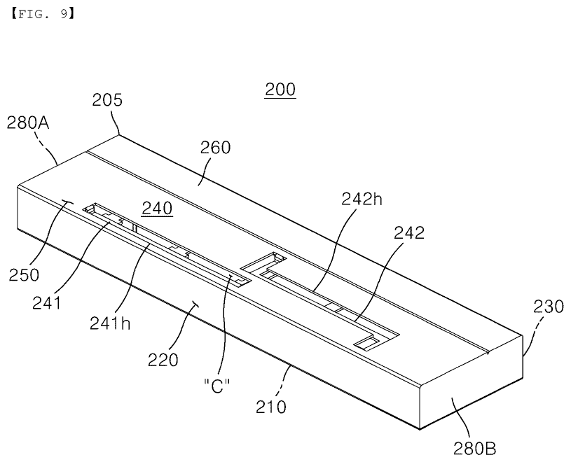

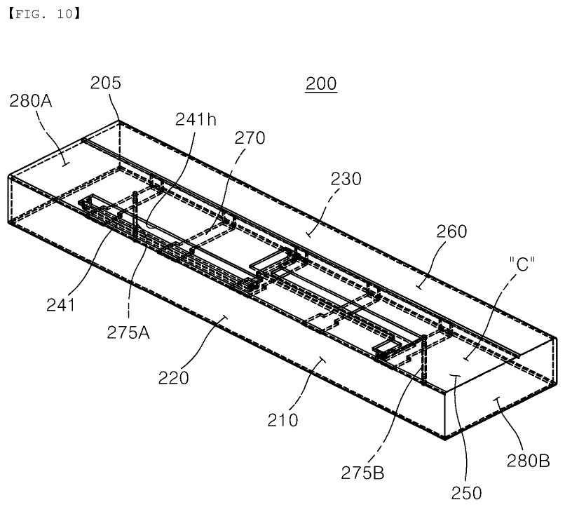

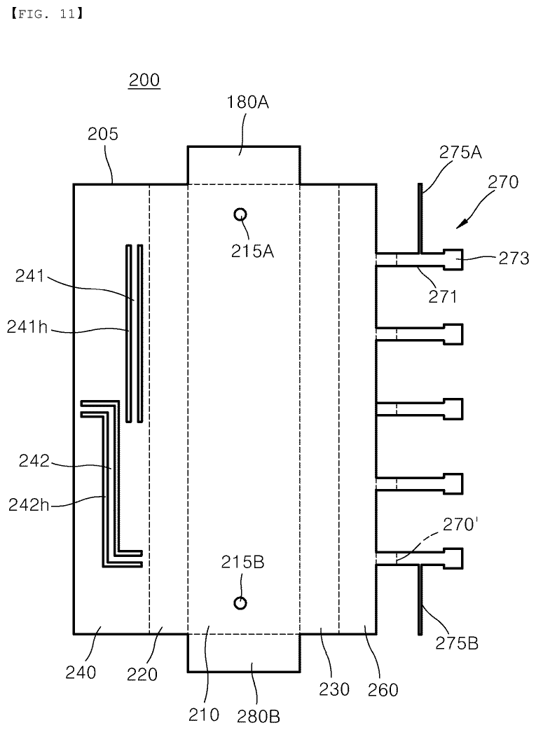

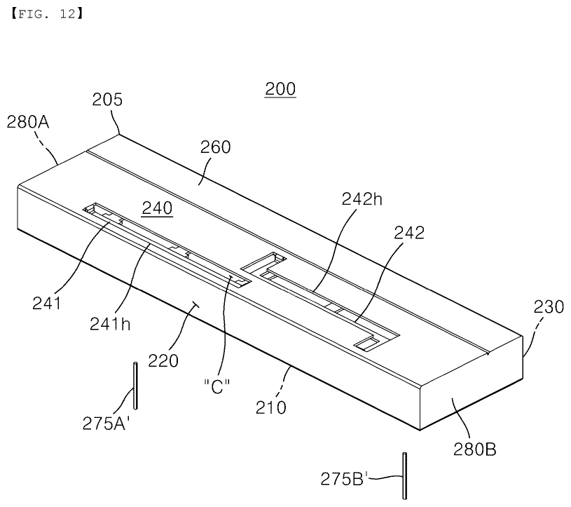

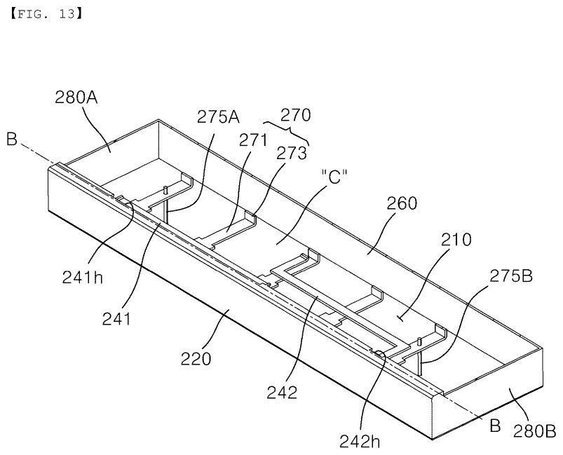

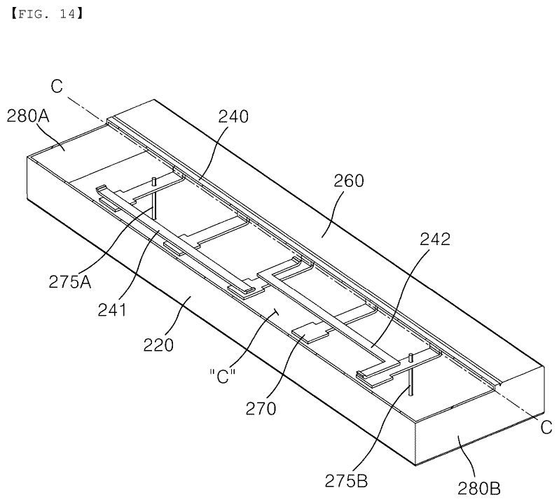

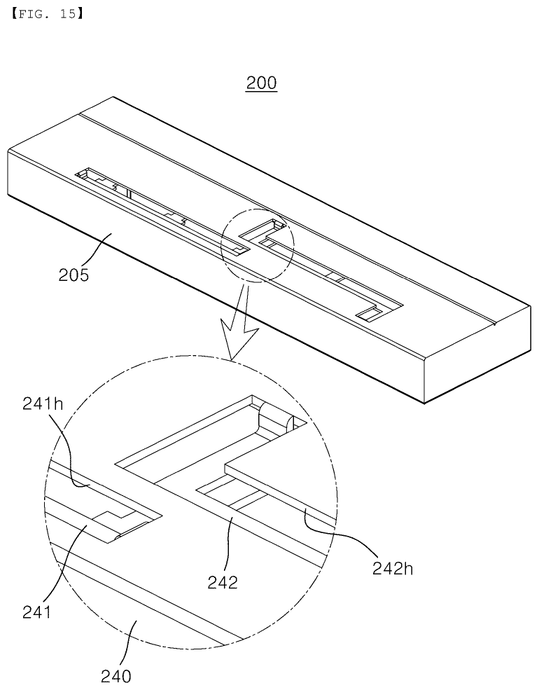

FIG. 9 is a perspective view illustrating a filter for communication devices according to a second embodiment of the present disclosure. FIG. 10 is an internal perspective view of FIG. 9. FIG. 11 is a plan view of a base plate among components of FIG. 9. FIG. 12 is an exploded perspective view illustrating an embodiment in which an input terminal pin and an output terminal pin among the components of FIG. 9 are provided as separate elements. FIGS. 13 and 14 are cutaway perspective views illustrating a state in which a portion of an upper plate forming part among the components of FIG. 9 is removed along lines B-B and C-C, respectively. FIG. 15 is a perspective view and a partially enlarged view of FIG. 9. FIG. 16 is a perspective view illustrating a second implementation of a plurality of resonators among the components of FIG. 9.

A filter 200 for communication devices according to the second embodiment of the present disclosure has the same technical features as the aforementioned first embodiment 100 in that, as referenced in FIGS. 9 to 16, a slim rectangular parallelepiped cavity C is formed through a folding process of each portion of a base plate 205, and a plurality of resonators 270, an L-notch portion 241, and a C-notch portion 242 are formed inside the cavity C to form distinct single layers, respectively, in a thickness direction.

More specifically, in the filter 200 for communication devices according to the second embodiment of the present disclosure, as referenced in FIGS. 9 to 16, the base plate 205 may include: a body bottom forming panel 210 that forms the bottom surface of the cavity C after folding; a first-side thickness forming panel 220 and a second-side thickness forming panel 230, which extend in a plane from a first widthwise end and a second widthwise end of the body bottom forming panel 210 such that the width thereof increases, thereby increasing the size of the cavity C in the thickness direction; a resonator panel 260, which extends from a distal end of either the first-side thickness forming panel 220 or the second-side thickness forming panel 230 (in the second embodiment of the present disclosure, the second-side thickness forming panel 230 corresponds thereto) and is provided with a plurality of resonators 270 that protrude into the cavity C at a position corresponding to space above the body bottom forming panel 210; and a body top forming panel 250, which extends from a distal end of the other of the first-side thickness forming panel 220 and the second- side thickness forming panel 230 and is provided to cover the top of the cavity C so as to face the body bottom forming panel 210, with an L-notch portion 241 and a C-notch portion 242 formed in the body top forming panel 250 by cutting.

Furthermore, a first-side shielding panel 280A and a second-side shielding panel 280B, which shield an open first longitudinal end and an open second longitudinal end of the cavity C, may integrally extend from the first longitudinal end and the second longitudinal end of the body bottom forming panel 210.

Here, the first-side shielding panel 280A and the second-side shielding panel 280B are not limited to being integrally formed with the body bottom forming panel 210, but depending on the embodiment, the first-side shielding panel 280A and the second-side shielding panel 280B may also be symmetrically and integrally provided on an adjacent panel (e.g., the body top forming panel 250). Furthermore, the first-side shielding panel 280A and the second-side shielding panel 280B may be integrally formed with adjacent panels so as to be separately provided as two components, respectively, and may be configured to completely shield the open portions of the cavity C through the folding operation.

Furthermore, in the filter 200 for communication devices according to the second embodiment of the present disclosure, the body bottom forming panel 210 may include an input port installation portion 215A and an output port installation portion 215B, which are formed to penetrate vertically a first longitudinal end and a second longitudinal end of the body bottom forming panel 210, respectively, as in the filter 100 for communication devices according to the first embodiment described above. An input terminal pin 275A may be installed through the input port installation portion 215A, and an output terminal pin 275B, which will be described later, may be installed through the output port installation portion 215B. As referenced in FIG. 7, a fixing protrusion portion 117 having a stud or serration-like projection shape may be integrally formed on an inner circumferential surface of a hole formed in each of the input port installation portion 215A and the output port installation portion 215B, where the input terminal pin 275A and the output terminal pin 275B are installed, to enable stable fixation of a Teflon component 118. The Teflon component 118 may be press-fitted and securely fixed, thereby creating the advantage of minimizing insertion loss.

In contrast to the filter 100 for communication devices according to the first embodiment of the present disclosure, in which the body top forming panel 150 and the resonator panel 160 have different thickness-direction heights and are thus formed with a step difference, the filter 200 for communication devices according to the second embodiment of the present disclosure features the body top forming panel 250 and the resonator panel 260 that have the same thickness-direction height and substantially perform a shielding function while each partially covering different portions of the top of the cavity C.

Furthermore, as referenced in FIGS. 9 to 16, the filter 200 for communication devices according to the second embodiment of the present disclosure differs in that, unlike the first embodiment 100, a separate notch forming panel with an L-notch portion 241 and a C-notch portion 242 is not provided, and instead, through a L-notch cutout 241h and a C-notch cutout 242h that are formed in the body top forming panel 250, portions of the body top forming panel 250 are integrally formed in advance in a partially cut shape so that the portions of the body top forming panel 250 can be deformed and protrude inward in the thickness direction of the cavity C using a certain tool or press during a press sheet metal process.

In the filter 200 for communication devices according to the second embodiment of the present disclosure, as referenced in FIG. 11, the plurality of resonators 270, rather than forming a single layer at the same height as the resonator panel 260, may each be bent along a bending line 270′ that is further formed to form a single layer within the cavity C at a position lower than the resonator panel 260 and the body top forming panel 250.

Furthermore, as referenced in FIG. 16, the plurality of resonators 270 may be formed in various implementations.

More specifically, the plurality of resonators 270 may each include, at a distal end portion thereof, a resonance characteristic end 273 that is bent perpendicularly to a longitudinal direction of the remaining portion (resonance bar 271) and has a greater width than the remaining portion.

As referenced in FIG. 16a, the resonance characteristic end 273 of each of the plurality of resonators 270 may integrally extend such that a rectangular one end thereof is bent perpendicularly to the leading end of the remaining portion (resonant bar 271).

Alternatively, as referenced in FIG. 16b, the resonance characteristic end 273 of each of the plurality of resonators 270 may integrally extend such that an arc-shaped central portion thereof with an open side is bent perpendicularly to the leading end.

Finally, the resonance characteristic end 273 of each of the plurality of resonators 270 may integrally extend such that a U-shaped central portion thereof with an open side is bent perpendicularly to the leading end.

The filter 200 for communication devices according to the second embodiment of the present disclosure also differs from the filter 100 for communication devices according to the first embodiment of the present disclosure in terms of the folding method and sequence of the base plate 205. The specific folding method and sequence are as referenced in FIG. 11.

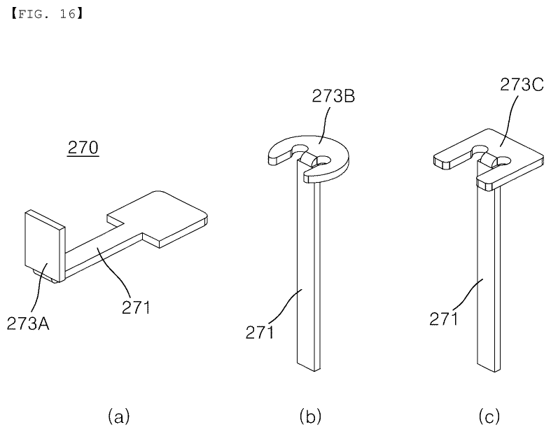

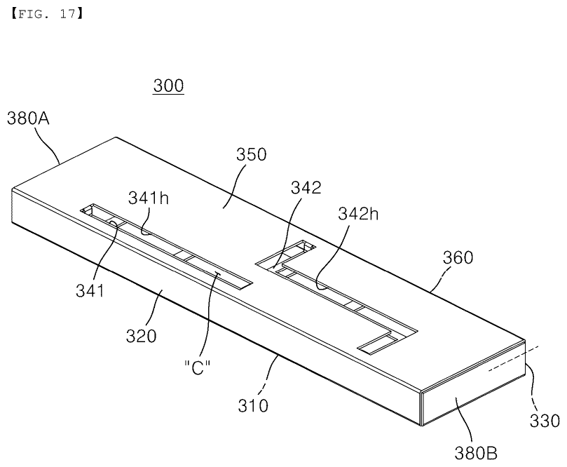

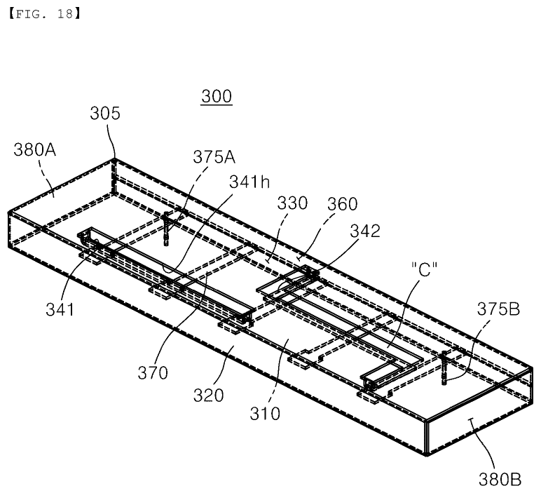

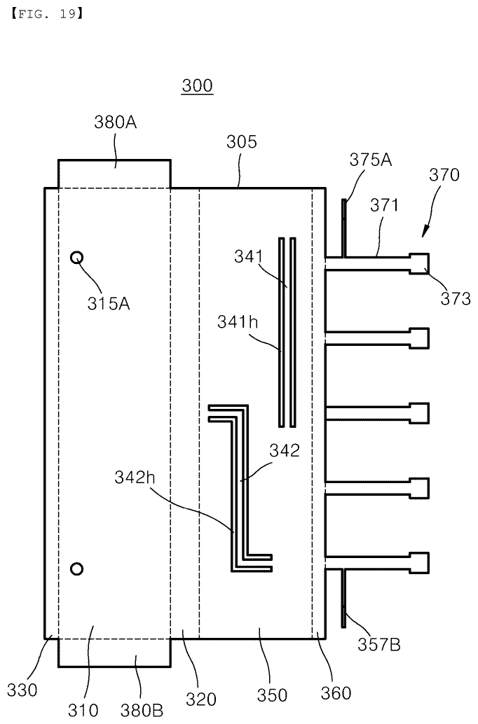

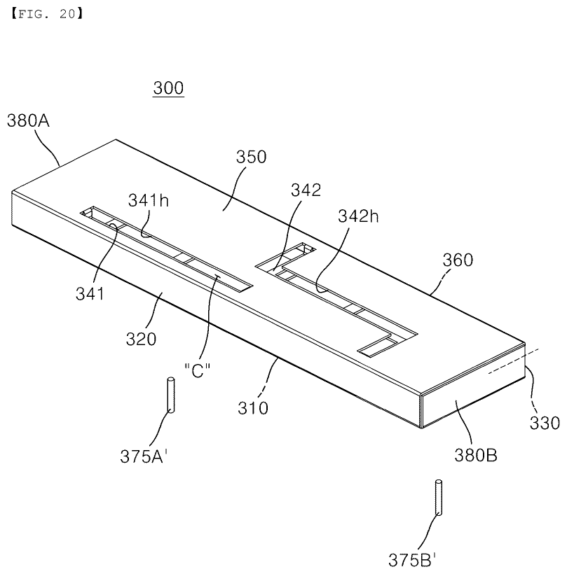

FIG. 17 is a perspective view illustrating a filter for communication devices according to a third embodiment of the present disclosure. FIG. 18 is an internal perspective view of FIG. 17. FIG. 19 is a plan view of a base plate among components of FIG. 17. FIG. 20 is an exploded perspective view illustrating an embodiment in which an input terminal pin and an output terminal pin among the components of FIG. 17 are provided as separate elements. FIG. 21 shows cutaway perspective views (a and b) taken along line D-D.

A filter 300 for communication devices according to the third embodiment of the present disclosure has the same technical features as the filter 100 for communication devices according to the first embodiment of the present disclosure and the filter 200 for communication devices according to the second embodiment of the present disclosure in that, as referenced in FIGS. 17 to 21, a slim rectangular parallelepiped cavity C is formed through a folding process of each portion of a base plate 305, and a plurality of resonators 370, an L-notch portion 341, and a C-notch portion 342 are formed inside the cavity C to form distinct single layers, respectively, in a thickness direction.

More specifically, in the filter 300 for communication devices according to the third embodiment of the present disclosure, as referenced in FIGS. 17 to 21, the base plate 305 may include: a body bottom forming panel 310 that forms the bottom surface of the cavity C after folding; a first-side thickness forming panel 320, which extends in a plane from a first widthwise end of the body bottom forming panel 310 such that the width thereof increases, thereby increasing the size of the cavity C in the thickness direction; a second-side thickness forming panel 330, which extends in a plane from a second widthwise end of the body bottom forming panel 310 such that the width thereof increases, thereby partially increasing the size of the cavity C in the thickness direction; a body top forming panel 350, which extends from the first-side thickness forming panel 320 and is provided to cover the top of the cavity C so as to face the body bottom forming panel 310, with an L-notch cutout 341h and a C-notch cutout 342h formed therein so that an L-notch portion 341 and a C-notch portion 342 can be processed; and a resonator panel 360, which extends from a second widthwise end of the body top forming panel 350 and is provided with a plurality of resonators 370 that protrude into the cavity C at a position corresponding to space above the body bottom forming panel 310.

Furthermore, a first-side shielding panel 380A and a second-side shielding panel 380B, which shield an open first longitudinal end and an open second longitudinal end of the cavity C, may integrally extend from the first longitudinal end and the second longitudinal end of the body bottom forming panel 310.

When comparing the filter 300 for communication devices according to the third embodiment of the present disclosure with the filter 100 for communication devices according to the first embodiment of the present disclosure already described, it differs in that a separate notch forming panel with the L-notch portion 341 and the C-notch portion 342 is not provided, and instead, through the L-notch cutout 341h and the C-notch cutout 342h formed in the body top forming panel 350, portions of the body top forming panel 350 are integrally formed in a partially cut shape so that the portions of the body top forming panel 350 can be deformed and protrude inward in the thickness direction of the cavity C by a predetermined tool or press machine.

Furthermore, in the filter 300 for communication devices according to the third embodiment of the present disclosure, a portion on which butt welding is ultimately performed in the configuration of the base plate 305 for forming the cavity C differs from that of the filter 200 for communication devices according to the second embodiment of the present disclosure. Specifically, in the second embodiment, the butt-welded portion is designed and implemented at the widthwise outer end of the body top forming panel 250 and the widthwise outer end of the resonator panel 260, where the plurality of resonators 270 are formed. In contrast, in the third embodiment, the second-side thickness forming panel 330, corresponding to half of the surface area, is integrally provided at the outer end of the body top forming panel 350, and the outer end of the resonator panel 360, to which the plurality of resonators 370 are connected, is configured to come into contact with the second-side thickness forming panel 330, allowing the butt welding to be performed.

The third embodiment 300 also differs from the first embodiment 100 and the second embodiment 200 in terms of the folding method and sequence of the base plate 305. The specific folding method and sequence are as referenced in FIG. 19.

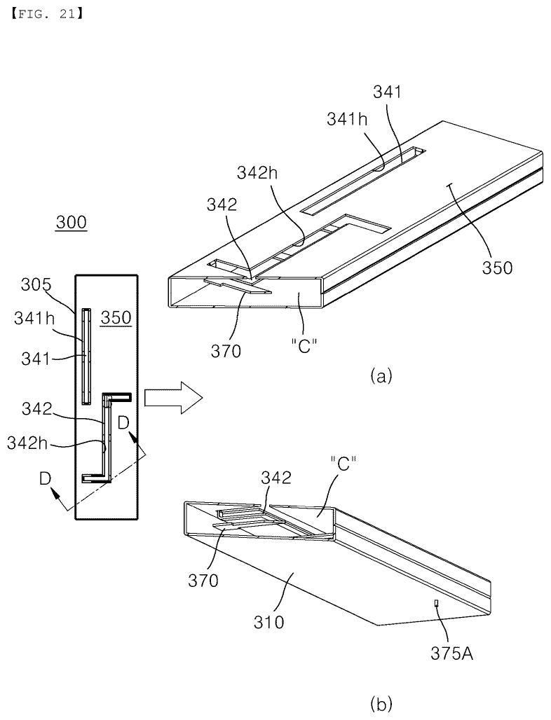

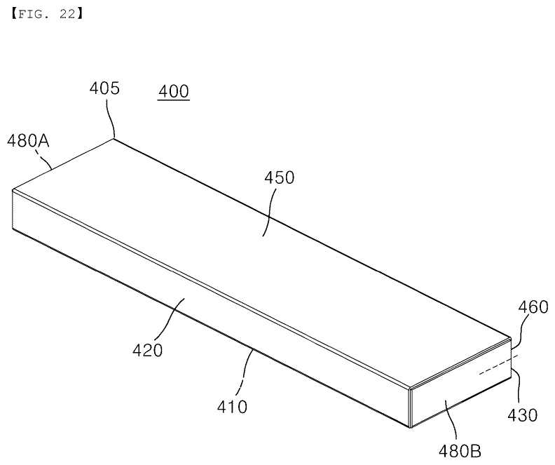

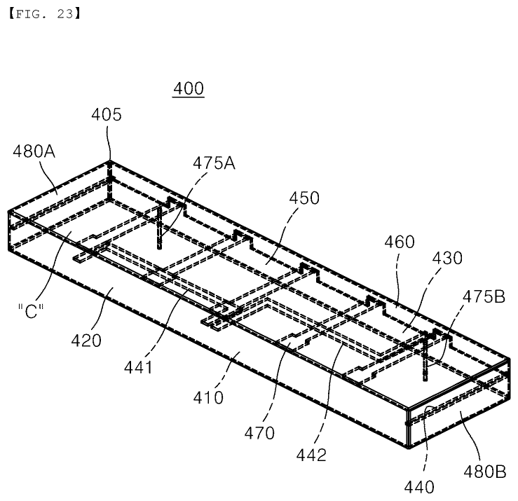

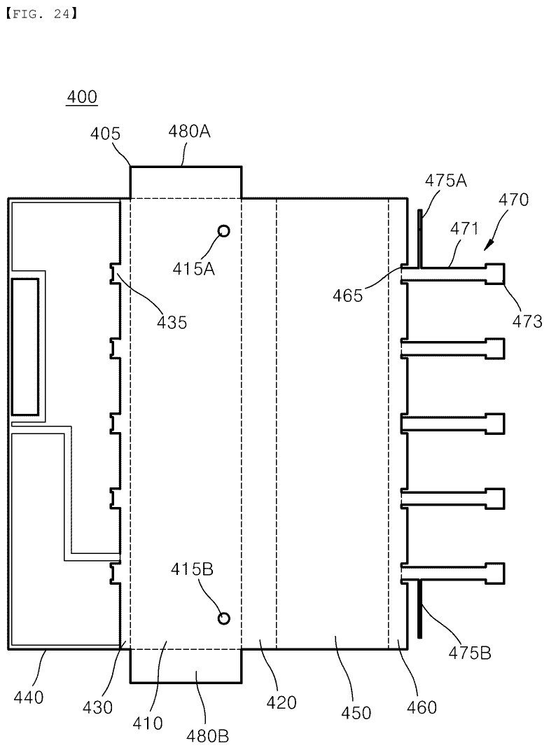

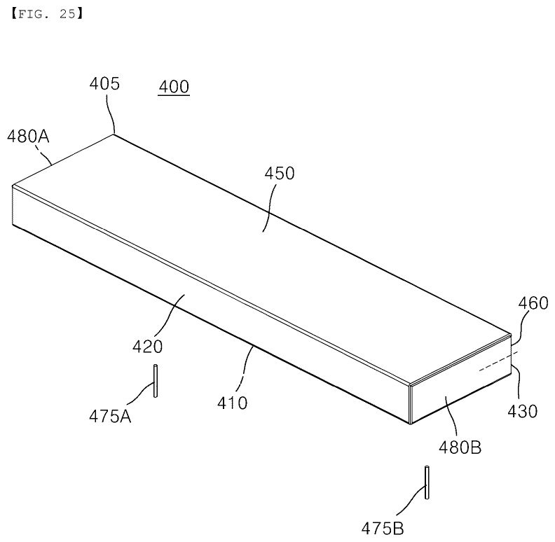

FIG. 22 is a perspective view illustrating a filter for communication devices according to a fourth embodiment of the present disclosure. FIG. 23 is an internal perspective view of FIG. 22. FIG. 24 is a plan view of a base plate among components of FIG. 22. FIG. 25 is an exploded perspective view illustrating an embodiment in which an input terminal pin and an output terminal pin among the components of FIG. 22 are provided as separate elements. FIG. 26 is a cutaway perspective view taken along line E-E.

A filter 400 for communication devices according to the fourth embodiment of the present disclosure has the same technical features as the aforementioned first to third embodiments 100 to 300 in that, as referenced in FIGS. 22 to 26, it forms a slim rectangular parallelepiped cavity C by folding each portion of a base plate 405, and a plurality of resonators 470, an L-notch portion 441, and a C-notch portion 442 are formed inside the cavity C to create distinct single layers, respectively, in a thickness direction.

More specifically, in the filter 400 for communication devices according to the fourth embodiment of the present disclosure, as referenced in FIGS. 22 to 26, the base plate 405 may include: a body bottom forming panel 410 that forms the bottom surface of the cavity C after folding; a first-side thickness forming panel 420, which extends in a plane from a first widthwise end of the body bottom forming panel 410 such that the width thereof increases, thereby increasing the size of the cavity C in the thickness direction; a second-side thickness forming panel 430, which extends in a plane from a second widthwise end of the body bottom forming panel 410 such that the width thereof increases, thereby partially increasing the size of the cavity C in the thickness direction; a body top forming panel 450, which extends in a plane from a widthwise outer end of the first-side thickness forming panel 420 such that the width thereof increases, and is provided in a shape that covers the top of the cavity C so as to face the body bottom forming panel 410; a resonator panel 460, which extends in a plane from an outer end of the body top forming panel 450 such that the width thereof increases, and is provided with a plurality of resonators 470 that protrude into the cavity C at a position corresponding to space above the body bottom forming panel 410; and a notch forming panel 440, which extends in a plane from an outer end of the second-side thickness forming panel 430 such that the width thereof increases, and is disposed in a single layer in the cavity C at a position that is above the body bottom forming panel 410 and lower than the resonator panel 460 and the plurality of resonators 470, with an L-notch portion 441 and a C-notch portion 442 formed therein.

Furthermore, a first-side shielding panel 480A and a second-side shielding panel 480B, which shield an open first longitudinal end and an open second longitudinal end of the cavity C, may integrally extend from the first longitudinal end and the second longitudinal end of the body bottom forming panel 410.

As referenced in FIGS. 22 to 26, the filter 400 for communication devices according to the fourth embodiment of the present disclosure differs from the first embodiment 100 in that the notch forming panel 440, in which the L-notch portion 441 and the C-notch portion 442 are formed, is provided to form a single layer positioned closer to the body bottom forming panel 410 in the thickness direction of the cavity C relative to the plurality of resonators 470.

Furthermore, as referenced in FIGS. 22 to 26, the filter 400 for communication devices according to the fourth embodiment of the present disclosure differs from the second embodiment 200 and the third embodiment 300 in that, in each of the plurality of resonators 470, a portion where a resonance bar 471 is formed is integrally formed with a recessed chamfered portion (see reference numeral ‘465’) not to be aligned with the end of the resonator panel 460, and a filling part 435 is further provided in the second-side thickness forming panel 430 to have a shape filling the separately chamfered portion of the resonator panel 460 through the folding process of the base plate 405.

The fourth embodiment 400 also differs from the first to third embodiments 100 to 300 in terms of the folding method and sequence of the base plate 405. The specific folding method and sequence are as referenced in FIG. 24.

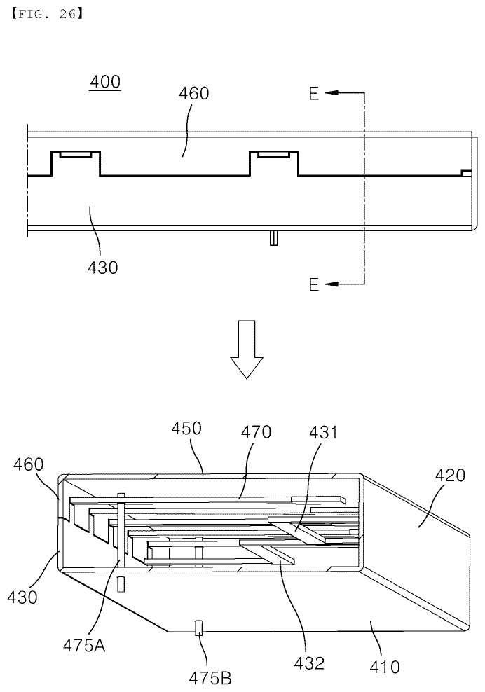

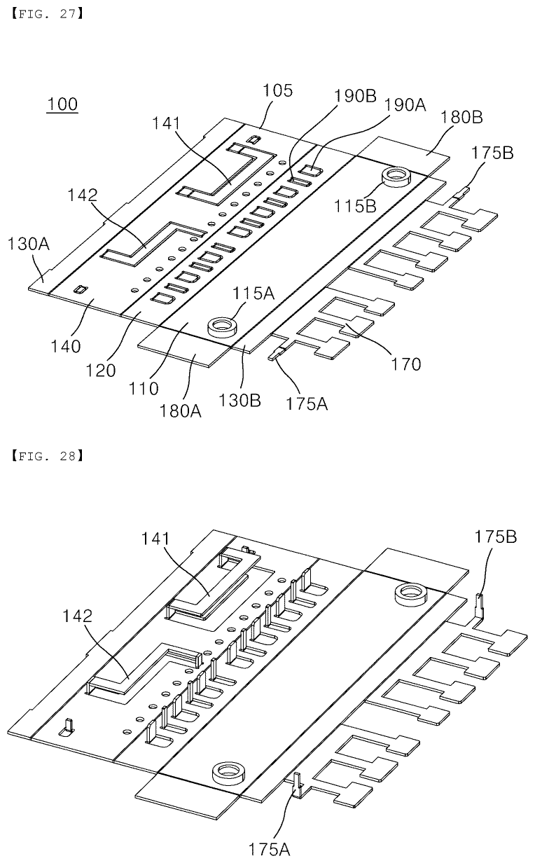

FIG. 27 is a perspective view illustrating an unfolded state of a form closest to an actual product according to embodiments of the present disclosure, and FIG. 28 is a perspective view illustrating a state in which a portion of the base plate of FIG. 27 is folded.

As referenced in FIGS. 27 and 28, the embodiments 100 to 400 of the present disclosure may further include a plurality of tuning bars 190A and a plurality of coupling adjustment bars 190B, which are integrally formed with the body top forming panel 150 to adjust a predetermined separation distance from the plurality of resonators 170 provided inside the cavity C through the folding process. Furthermore, prior to the main folding process of the initial base plate 105, as referenced in FIG. 28, the tuning bars 190A, the coupling adjustment bars 190B, the L-notch portion 141, the C-notch portion 142, and the resonators 170 may be folded in accordance with the design. Here, the first terminal pin 175A and the second terminal pin 175B may also be folded through the folding process so as to be bent toward the input port installation portion 115A and the output port installation portion 115B.

Thus far, the filters 100 to 400 for communication devices according to the embodiments of the present disclosure have been described in detail with reference to the accompanying drawings. However, embodiments of the present disclosure are not limited to the foregoing embodiments, and it is apparent to those skilled in the art that various changes may be made thereto without departing from the claims and equivalents thereof. Accordingly, the true scope of the present disclosure should be defined by the appended claims.

### INDUSTRIAL APPLICABILITY

The present disclosure provides a filter for communication devices that can eliminate conventional joining processes for forming a cavity and providing structures such as resonators within the cavity, thereby reducing insertion loss caused by coupling of two physical structures.

1. A filter for communication devices, comprising a base plate made of a conductive material, and manufactured in an unfolded state, the base plate being configured foldable such that, upon folding, a cavity is formed inside while simultaneously positioning a plurality of resonators to protrude by a set length in a thickness direction or a width direction in the cavity,
wherein the plurality of resonators each include, at a distal end portion thereof, a resonance characteristic end that is flat to form a layer identical to a remaining portion in the cavity and has a greater width than the remaining portion.

2. The filter of claim 1,
wherein at least one of the plurality of resonators is integrally formed with an input terminal pin connected to an input port so that a signal transmitted from the input port is received, and
wherein at least one other of the plurality of resonators is integrally formed with an output terminal pin connected to an output port so that a signal is transmitted to and output from the output port.

3. The filter of claim 1, wherein the resonance characteristic end of each of the plurality of resonators integrally extends to be angled from a leading end of the remaining portion.

4. The filter of claim 1, wherein the resonance characteristic end of each of the plurality of resonators is integrally formed to extend to be rounded from a leading end of the remaining portion.

5. The filter of claim 1, wherein the resonance characteristic end of each of the plurality of resonators integrally extends in a “U” shape that surrounds a leading end of the remaining portion.

6. The filter of claim 1,
wherein the base plate is made of either a conductive material or a non-conductive material, and
wherein in case that the base plate is made of the non-conductive material, a conductive material is formed as a coating layer by plating at least on an interior corresponding to the cavity.

7. The filter of claim 1, wherein the cavity is filled with air having a dielectric constant of 1.

8. The filter of claim 1, wherein the base plate, after folding, comprises:
a body bottom forming panel that forms a bottom surface of the cavity;
a first-side thickness forming panel and a second-side thickness forming panel that increase a size of the cavity C in a thickness direction;
a resonator panel provided with a plurality of resonators that protrude into the cavity at a position corresponding to space above the body bottom forming panel; and
a body top forming panel provided in a shape covering a top of the cavity.

9. The filter of claim 8, wherein the base plate, after folding, further comprises a first-side shielding panel and a second-side shielding panel that shield a first longitudinal end and a second longitudinal end of the cavity.

10. The filter of claim 8, wherein the base plate, after folding, further comprises a notch forming panel provided between the body top forming panel and the plurality of resonators of the resonator panel.

11. The filter of claim 8,
wherein at least one of the plurality of resonators is integrally formed with an input terminal pin connected to an input port so that a signal transmitted from the input port is received,
wherein at least one other of the plurality of resonators is integrally formed with an output terminal pin connected to an output port so that a signal is transmitted to and output from the output port,
wherein an input port installation portion and an output port installation portion, through which the input terminal pin or the output terminal pin are installed are formed in a boss shape to vertically penetrate through the body bottom forming panel, wherein a fixing protrusion portion for securing installation of a Teflon component is formed, to have a stud or serration-like projection shape, on an inner circumferential surface of a hole defined in each of the input port installation portion and the output port installation portion.
